(19) United States
(12) Patent Application Publication
(10) Pub. No.: US 2013/0056471 A1
(43) Pub. Date: Mar. 7, 2013

(54) Gum Holder

(71) Applicants: David W. Ervin, Plainfield, NJ (US); Eric C. Watson, Plainfield, NJ (US)

(72) Inventors: David W. Ervin, Plainfield, NJ (US); Eric C. Watson, Plainfield, NJ (US)

(21) Appl. No.: 13/403,342

(22) Filed: Feb. 23, 2012

Related U.S. Application Data
(60) Provisional application No. 61/446,580, filed on Feb. 25, 2011.

(51) Int. Cl. B65F 1/06

(52) U.S. Cl. 220/495.08

(57) ABSTRACT

The present invention relates to a disposal container for used chewing gum and the like having a circular container having at least one side wall and a floor member; the sidewall extending substantially perpendicularly from the bottom wall to define an interior of the container; the sidewall having an upper rim and an opening opposite to the floor member for gum disposal and bag removal; and at least one hook insert being attached to the upper rim of the sidewall; a removable disposable liner being fixedly attached to the at least one hook insert; a detachable lid attached to a hinged mounting bracket located on the outer edge of the upper rim of the sidewall to enclose the opening opposite to the floor member. The chewing gum disposal device of the present invention may be wall mountable or mountable on a base stand member.

### CLAIM OF PRIORITY

This application claims priority from U.S. provisional application 61/446,580, filed on Feb. 25, 2011.

### FIELD OF THE INVENTION

This invention generally pertains to the field of waste disposal devices and containers and is more particularly related to devices for the disposal of used chewing gum. The present invention relates to a chewing gum disposal container having a liner which may be wall mounted or placed on a stand having a hinged top closure lid.

### BACKGROUND OF THE INVENTION

Various receptacles and devices for the disposal of used chewing gum are known. Some of these prior art suggestions are described below in a listing which is exemplary, but not necessarily all-inclusive.

U.S. Pat. No. 4,483,440 to Ware relates to a disposal device for gum and the like having a generally cubical housing, a disposable bag removably supported therein, and appropriate access openings for gum disposal and bag removal. Each of the side walls of the housing is formed with a slot therein for the insertion of a sheet of advertising or other printed display material. The side walls are made of transparent or clear plastic material for best viewing the display material. The housing includes a recess in one of the side walls for holding a packet of wrapping tissues for the sanitary disposal of spent chewing gum. A turntable supports the housing for easy rotation on a table top, such that the side wall mounted tissues may be brought within convenient reach, and the display panels may be readily viewed by many persons seated at the same table. The interior of the box has a disposable flexible plastic container.

U.S. Pat. No. 3,960,269 to Jenkins is directed to a combination ash tray and gum disposal wherein tissue paper is provided for disposing of masticated gum and disposing into a relatively small hole in a receptacle.

GB Patent 2263897 to Anderson is directed to a device for storing gum sticks or pieces and a disposal unit as well. It may also contain advertising on the outside portions. No lining, paper or otherwise is utilized.

International Patent Publication No. WO/2007/028973 to Carr is directed to a preferably mushroom-shaped chewing gum disposal device is described. The device comprises a body defining a lip adapted to receive a piece of chewed gum. The lip is downwardly depending outwardly from the body. In one embodiment the body comprises a cylindrical or tubular section and a cap section, the lip being defined by the cap section.

WO/2006/029049 (also U.S. Pat. No. 7,563,468 and U.S. Patent Publication No. 20060051457) to Bougoulas (Wrigley) is directed to a chewing gum package made from an outer package containing one or more pieces of chewing gum. The package includes at least one disposal sheet to wrap chewing gum cuds for proper disposal. The presence of the disposal sheet serves as a reminder to the consumer to dispose of chewing gum cuds appropriately.

International Patent Publication No. WO/2005/100173 to Levenig is directed to a chewing gum disposal box characterized in that it has a state-of-use and a state of transport. In the state-of-use, the chewing gum disposal box is erected to give a main compartment having side walls and a bottom, and an additional compartment having side walls and a bottom. In the state of transportation, the bottoms are disposed substantially parallel to the side walls.

U.S. Patent Publication No. 20090294321 to Craig is directed to a chewing gum disposal system and method. The chewing gum disposal system includes a plurality of chewing gum disposal envelopes configured to receive one or more pieces of chewing gum, and a chewing gum disposal container. The disposal container has a holding compartment configured to hold the chewing gum disposal envelopes, and a disposal compartment configured to receive one or more chewing gum disposal envelopes having pieces of chewing gum therein. In disposing of a piece of chewing gum, an envelope is removed from the holding compartment, the piece of chewing gum is placed inside the envelope, and the envelope is inserted into the disposal compartment.

U.S. Pat. No. 7,380,666 to Buckelew is directed to a gum disposal apparatus for permitting a user to easily dispose of chewed gum includes a plurality of disposal sheets. Each of the disposal sheets is positionable around a piece of chewed gum. A cover extends around a portion of the disposal sheets to keep the disposal sheets in a stacked arrangement. A securing member secures the disposal sheets to the cover wherein individual ones of the disposal sheets may be torn away from the securing member.

U.S. Pat. No. 6,830,152 to Smith is directed to a gum disposal pocket includes a back wall, a pair of foldable side wings extended from two sides of the back wall respectively, a holding panel extended from a top side of the back wall and adapted for holding the pair of side wings in position, and a pocket cover extended from a top side of the front panel and adapted for closing and sealing the gum disposal pocket.

In conventional waste basket containers, it is common practice to fold the lip of a liner over the upper edge of the waste disposal container in order to retain a waste basket liner in place. Often the waste disposal container will be designed to have an attractive appearance and the unkempt effect of the visible liner considerably detracts from the overall appearance of the waste disposal container. In addition, the liner may collapse into the interior of the waste disposal container thus allowing waste to pass between the waste disposal container wall and the liner thus soiling or even permanently damaging the waste disposal container.

Despite all of this, however, the need still remains for a quick, efficient, space saving, aesthetically pleasing container having a supported liner to properly dispose of used chewing gum thus preventing littering.

### SUMMARY OF THE INVENTION

A chewing gum disposal device is disclosed having a circular container having at least one side wall and a floor member; the sidewall extending substantially perpendicularly from the bottom wall to define an interior of the container; the sidewall having an upper rim and an opening opposite to the floor member; at least one attachment assembly, preferably a hook insert being attached to the upper rim of the sidewall; a removable liner being fixedly attached to the at least attachment assembly; and a lid attached to a hinged lid mount located on the outer edge of the upper rim of the sidewall to enclose the opening opposite to the floor member.

In one embodiment of the present invention, a chewing gum disposal device is provided having a circular container having a liner within the container; said liner defining a cavity or pouch for dispensing of used chewing gum within the container. The liner includes an opening at one end opposite to the bottom wall of the container. The liner is fixedly attached to at least one hook insert located along the periphery of an upper rim of the sidewall.

In a preferred embodiment, there are at least 8 hook inserts located on the periphery of the sidewall.

In one embodiment of the present invention, a wall mounted chewing gum disposal container having a hinged top closure lid is provided. The container includes a lid mount which is fitted in a sealing manner upon the top of the container, and a lid which is attached to the lid mount.

In one embodiment of the present invention, a chewing gum disposal container mountable on a base stand member having a hinged top closure lid is provided. The container includes a lid mount which is fitted in a sealing manner upon the top of the container, and a lid which is attached to the lid mount.

It is an object of the present invention to provide a quick, efficient, space saving, aesthetically pleasing container to properly dispose of used chewing gum thus preventing littering.

### BRIEF DESCRIPTION OF THE DRAWINGS

The invention will be better understood by reference to the following description, taken in connection with the accompanying drawings, in which:

FIG. 1 is a perspective view of a preferred embodiment of the invention with the top open and pieces of gum pressed onto the liner.

FIG. 2 is a front view with lid closed.

FIG. 3 is a side view showing the holder mounted to a wall.

FIG. 4 is a side cutaway view, showing the hooks and liner, with gum stuck to the liner.

FIG. 5 is a top view with lid closed.

FIG. 6 is a top view with the lid open and the liner and hooks exposed.

FIG. 7 is perspective view of an alternate embodiment showing the gum holder on a stand.

These drawings are for illustrative purposes only and should not be used to unduly limit the scope of the invention.

### DETAILED DESCRIPTION OF THE INVENTION

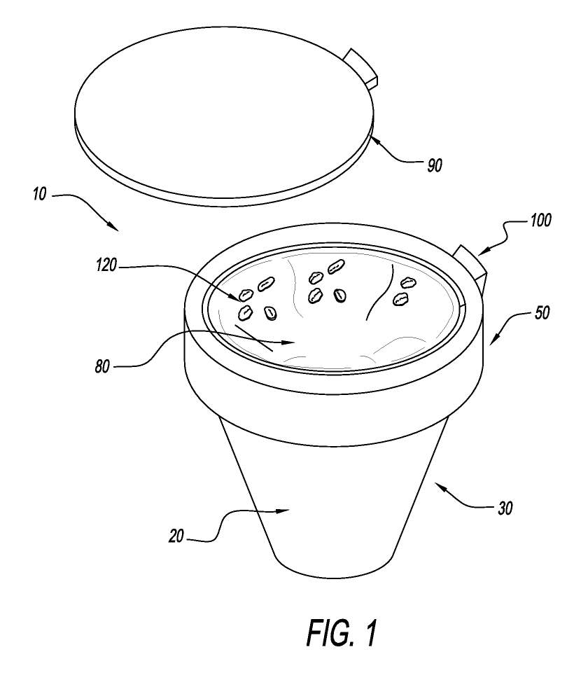

Embodiments of the invention are discussed below with reference to FIGS. 1-7. However, those skilled in the art will readily appreciate that the detailed description given herein with respect to these figures is for explanatory purposes as the invention extends beyond these limited embodiments.

In the drawings, where like numerals identify like elements, there is shown various forms of a chewing gum disposal device of the present invention. The chewing gum disposal device is generally designated by the numeral 10.

As shown in FIG. 1, a chewing gum disposal device 10 is provided having a detachable lid 90 that is detached from a hinged mounting bracket 100 located on an outer edge of an upper rim 50 of the sidewall 30. FIG. 1 also shows a removable liner 80 being fixedly attached to at least one hook insert (not shown) located at the upper rim 50 of the sidewall 30 with pieces of gum 120 pressed onto the liner 80.

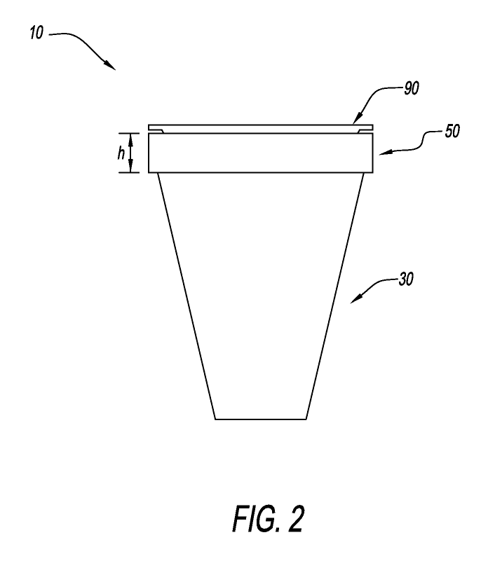

FIG. 2 shows a front view of a chewing gum disposal device 10 with a detachable lid 90 located on an outer edge of an upper rim 50 of the sidewall 30; said detachable lid being in a closed position. The upper rim 50 of the sidewall 30 lies a distance h below the upper edge of the sidewall 30 of the chewing gum disposal device 10. The distance h is small relative to the total height of the sidewall 30, but sufficiently large to place at least one hook insert around its periphery.

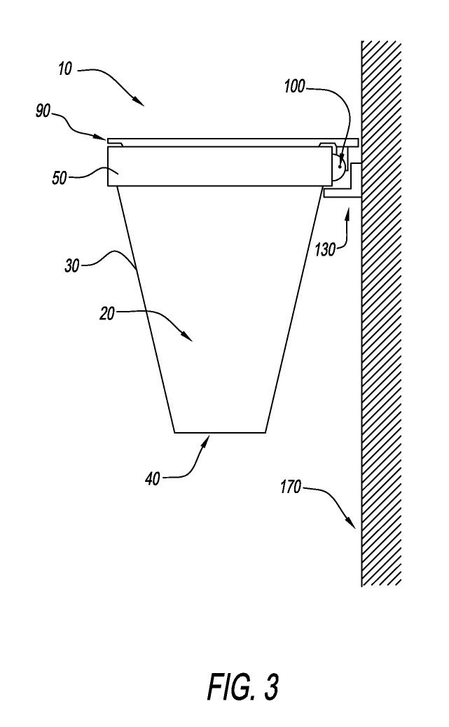

As shown in FIG. 3, a chewing gum disposal device 10 is disclosed having a circular container 20 having at least one side wall 30 and a floor member 40. The sidewall 30 extends substantially perpendicularly from the floor member 40 to define an interior of the container 20. The sidewall 30 has an upper rim 50 and an opening opposite to the floor member that is sealed with a lid 90. Lid 90 is preferably detachable. Lid 90 is attached to a hinged mounting bracket 100 located on the outer edge of the upper rim 50 of the sidewall to enclose the opening opposite to the floor member. As shown in FIG. 3, the chewing gum disposal device is attached to wall 170 by wall attachment means 130.

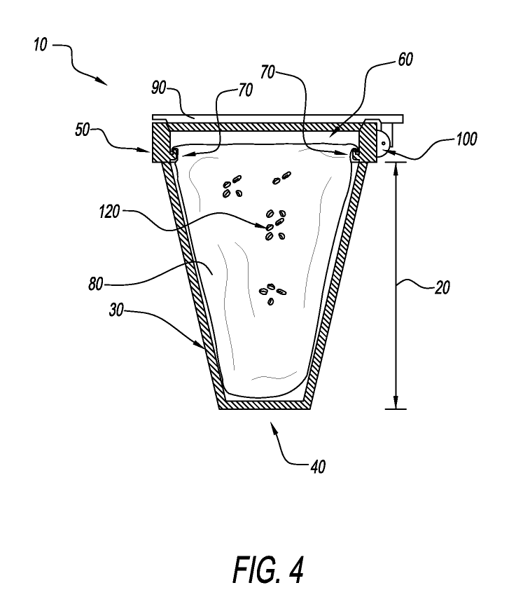

As shown in FIG. 4, an embodiment of chewing gum disposal device 10 of the present invention may have a circular container 20 having at least one side wall 30 and a floor member 40. The sidewall 30 extends substantially perpendicularly from the floor member 40 to define an interior of the container 20 for holding used chewing gum. The sidewall 30 has an upper rim 50 and an opening 60 opposite to the floor member 40. At least one hook insert 70 is attached to the upper rim 50 of the sidewall 30. A removable liner 80 is fixedly attached to the at least one hook insert 70; wherein pieces of gum 120 may be pressed onto the liner 80. The interior of the liner 80 preferably presents a shape which is substantially equivalent to the shape of the container 20. A lid 90 is attached to a hinged mounting bracket 100 located on the outer edge of the upper rim 50 of the sidewall to enclose the opening opposite to the floor member. Preferably, the lid is detachable and will allow a custodian to easily remove the liner when it is filled with chewing gum.

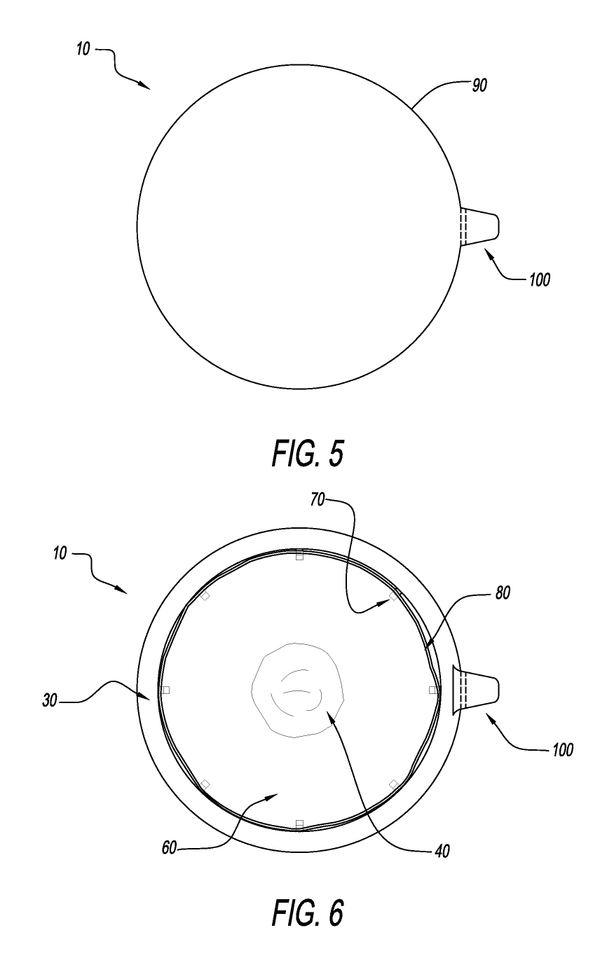

FIG. 5 shows a top view of an embodiment of chewing gum disposal device 10 of the present invention wherein a lid 90 located on an outer edge of an upper rim 50 of the sidewall 30 is in a closed position. The lid 90 is attached to a hinged mounting bracket 100 located on the outer edge of the upper rim of the sidewall. The mounting bracket allows the device to be held securely to a wall or other upright structure. The bracket must be of sufficient strength to maintain the position of the container 20 while a user is applying pressure against it during the application of chewing gum 120 to the removable liner 80, and to withstand the abuse the container 20 would be subject to in public.

FIG. 6 depicts a top view of an embodiment of chewing gum disposal device 10 of the present invention with a detachable lid 90 in an open position. FIG. 6 depicts an embodiment of the chewing gum disposal device 10 having a circular container 20 having at least one side wall 30. The sidewall 30 has an upper rim and an opening 60 opposite to the floor member 40. Attachment assembly 70 is shown as eight hook inserts being attached to the upper rim of the sidewall 30. Other types of attachment assemblies include clamping mechanisms, clips, two part compression rings, tape or adhesives, The attachment assembly must be able to secure the liner and hold the liner in place while weighted with multiple pieces of chewing gum attached thereto. A removable liner 80 is fixedly attached to the at least one hook insert 70. A hinged mounting bracket 100 is located on the outer edge of the upper rim of the sidewall wherein a detachable lid (not shown) may be attached to enclose the opening 60 opposite to the floor member 40.

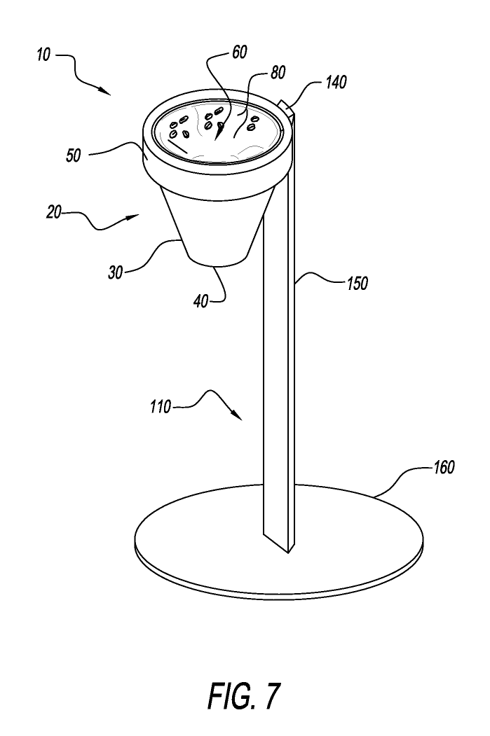

FIG. 7 depicts an alternate embodiment of the present invention showing the chewing gum disposal device on a stand. As shown in FIG. 7, a chewing gum disposal device 10 is disclosed having a circular container 20 having at least one side wall 30 and a floor member 40; the sidewall 30 extending substantially perpendicularly from the floor member 40 to define an interior of the container 20; the sidewall 30 having an upper rim 50 and an opening 60 opposite to the floor member; at least one hook insert (not shown) being attached to the upper rim 50 of the sidewall 30; a removable liner 80 being fixedly attached to the at least one hook insert. A connection assembly 140 attaches the upper rim 50 to a base stand member 110. As depicted in FIG. 7, the base stand member 110 comprises a post 150 attached to a base unit 160. The base unit may be in various shapes, including but not limited to a square, rectangle or circular.

The container 20 may be made of various materials including but not limited to, plastic, polyethylene, metal, vinyl, wood and composite materials. The container 20 can also be different shapes or could be in the form of a large gumball, cartoon character, sports ball, such as a base ball, etc.

The dimensions of the circular container 20 are can be from 3 to 48 inches (7.6 to 122 cm) in diameter at its widest point and, from 3 to 48 (7.6 to 122 cm) inches in height.

The hook inserts 70 may be made of metal or any other suitable material capable of maintaining the liner 80 fixed relative to the upper rim 50 of the sidewall.

The liner may be made of various materials including but not limited to, plastic, polyethylene, paper, cardboard, foil laminate or a polymer film. The liner is ideally disposable and has a texture suitable for retaining chewing gum when it is stuck to the side. The lines should be suitably strong to not tear or rip when it is being pulled from the container 20 after it is filled with gum.

The lid 90 may be made of various materials including but not limited to, plastic, polyethylene, metal, vinyl, wood and composite materials.

The dimensions of the lid 90 are from 3 to 48 inches inches (7.6 to 122 cm) in diameter.

The chewing gum disposal device 10 is shown as having a generally circular cross-section, although it will be understood to one skilled in the art that the invention applies equally well to bins of rectangular cross-section or any other cross-section.

A wall attachment means 130 or base stand member 110 is provided for mounting the chewing gum disposal container at any convenient locations, including but not limited to, entrances of buildings, street corners and parks.

It is contemplated that the present invention may be employed in dispensing items other than chewing gum. The description of the present invention for dispensing chewing gum is only illustrative and is not intended to limit the scope of the present invention. Furthermore, the present invention may be embodied in other specific forms without departing from the spirit or essential attributes thereof and, accordingly, reference should be made to the appended claims, rather than to the foregoing specification, as indicating the scope of the invention.

The advantages of the invention are numerous. Different aspects, embodiments or implementations may yield one or more of the following advantages. One advantage of the invention is that it provides a quick and efficient space saving container to properly dispose of used chewing gum thus preventing littering.

Although the invention has been described with reference to specific embodiments, it will be understood by those skilled in the art that various changes may be made without departing from the spirit or scope of the invention. Various examples of such changes have been given in the foregoing description. Accordingly, the disclosure of embodiments of the invention is intended to be illustrative of the scope of the invention and is not intended to be limiting. For example, to one of ordinary skill in the art, it will be readily apparent that the system discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment of the invention, and may disclose alternative embodiments of the invention.

What is claimed:

1. A chewing gum disposal device comprising:
a circular container having at least one sidewall and a floor member;
the at least one sidewall extending substantially perpendicularly from the floor member to define an interior of the container;
the sidewall having an upper rim and an opening opposite to the floor member, the upper rim having an outer edge;
at least one attachment assembly being attached to the upper rim of the sidewall;
a removable liner being fixedly attached to the attachment assembly;
a lid attached to a hinged lid mount located on the outer edge of the upper rim of the sidewall to enclose the opening opposite to the floor member.

2. The chewing gum disposal device of claim 1, wherein the device is wall mountable.

3. The chewing gum disposal device of claim 1, wherein the device is mountable on a base stand member.

4. The chewing gum disposal device of claim 1, where in the attachment assembly further comprises at lease one hook insert.

5. The chewing gum disposal device of claim 1 wherein eight hook inserts are attached to the upper rim of the sidewall.

6. The chewing gum disposal device of claim 1 wherein the lid is detachable.

7. The chewing gum disposal device of claim 1 wherein the device has a mounting bracket suitable for mounting the container to a wall and that can withstand pressure from a user when placing gum against the side wall of the container.

8. The chewing gum disposal device of claim 1 wherein the liner allows gum to frictionally adhere to the liner.
